(19) United States
(12) Patent Application Publication
(10) Pub. No.: US 2011/0307807 A1
(43) Pub. Date: Dec. 15, 2011

(54) Game Invitations Through Peer-to-Peer Chat

(76) Inventor: Vibhu Norby, Palo Alto, CA (US)

(21) Appl. No.: 12/816,029

(22) Filed: Jun. 15, 2010

(51) Int. Cl. G06F 3/01

(52) U.S. Cl. 715/758; 715/760

(57) ABSTRACT

A web-server engagement invitation system operates from a computerized internet-connected server having a plurality of clients, and serves content as web pages or presentations to individual ones of the clients through software executing from a machine-readable medium. A chat system operable by the server through the software provides chat communication between individual ones of the clients online. An invitation system operable through the chat system, enables a first client engaged in or entering one of the pages or presentations to issue an invitation to one or more other receiving clients to enter the same page or presentation, the invitation served as a chat message through the chat system.

### BACKGROUND OF THE INVENTION

1. Field of the Invention

The present invention is in the field of virtual reality (VR) systems including on-line VR games, and pertains more particularly to game invitations from user-to-user.

2. Discussion of the State of the Art

In the art of computer-aided modeling, virtual reality environments are created and exist for such as educational and entertainment purposes. Virtual reality games, three dimensional toys, and other types of virtual environments exist where clients subscribe to a gaming site or virtual-world site and engage in interaction with the virtual presentations, typically through a character representing the client/user, that character termed in the art an Avatar. In some cases several different sorts of VR activity may be integrated in a single site; that is, VR games, toys, social interaction, and the like, may all be accessed through a common site. One such site may be experienced at ROBLOX.com, for example.

At a VR site such as Roblox, users are required to register, and then may enter the site via log-in, entering a username and a password. At any point in real time there may be a relatively large number of users logged in and participating in activities through functionality of the site, or simply browsing the site. Administrative functions track each user while engaged until the user logs out, and other functions serve to enhance the user's experience and to store use history.

Some games available at a site as described above may be games in which two or more users may participate interactively, using avatars representing each participating user, with each user in control of his or her avatar. Such games may also in other instances allow teams of users to engage other teams of users in contests, may allow individual users (through their respective avatars) to contest in some way, or may provide cooperative projects in which a plurality of users may participate.

In state-of-the-art systems methods and functions for selecting users who might participate, and integrating the participation of individual users in games and VR projects of the sort described above are somewhat difficult and hard to follow. Therefore, what is needed is a proactive and user-friendly way for users to join other users in such games and activities.

### SUMMARY OF THE INVENTION

The inventor has recognized a need for smoothly and effortlessly engaging, by one client, other clients to engage in a web page or presentation, and has invented a way to accomplish this through a chat system.

In one embodiment of the invention a web-server engagement invitation system is provided, comprising a computerized internet-connected server having a plurality of clients, serving content as web pages or presentations to individual ones of the clients through software executing from a machine-readable medium, a chat system operable by the server through the software, providing chat communication between individual ones of the clients online, and an invitation system operable through the chat system, enabling a first client engaged in or entering one of the pages or presentations to issue an invitation to one or more other receiving clients to enter the same page or presentation, the invitation served as a chat message through the chat system.

In one embodiment the presentations are virtual reality activities and/or games. Also in an embodiment, upon selecting the invitation message by the receiving client, a URL is asserted directing the receiving client's web browser to the page or presentation engaged in or being entered by the first client. In another aspect, upon selecting the invitation message by the receiving client, a URL is asserted directing the receiving client's web browser to the virtual reality activity or game engaged in or about to be entered by the first client.

In some embodiments the first client has a contact or friend association, and upon initiating the invitation process, a list of the client's contacts is presented, wherein the client may select or exclude contacts to receive the invitation. Constraints may be placed on the contacts list by the system.

In another aspect of the invention a method for web-server engagement is provided, comprising the steps of (a) serving content as web pages or presentations to individual clients among a plurality of clients by a computerized internet-connected server, through software executing from a machine-readable medium; (b) providing a chat system operable by the server through the software, enabling chat communication between individual ones of the clients online; and (c) issuing an invitation by a first client to one or more other receiving clients to enter the same page or presentation, the invitation served as a chat message through the chat system.

In one embodiment of the method, in step (a) the presentations are virtual reality activities and/or games. Also in one embodiment there may be a further step for selecting the invitation message by the receiving client, thereby asserting a URL directing the receiving client's web browser to the page or presentation engaged in or being entered by the first client. In another aspect the URL directs the receiving client's web browser to the virtual reality activity or game engaged in or being entered by the first client.

In some embodiments of the method the first client has a contact or friend association, and there may be a step for presenting a list of the client's contacts upon initiating the invitation process, wherein the client may select or exclude contacts to receive the invitation. Constraints may be placed on the contacts list by the system.

### BRIEF DESCRIPTION OF THE DRAWING FIGURES

FIG. 1 is an architectural overview of a communications network supporting user participation in a web-based Virtual Reality site in an embodiment of the present invention.

FIG. 2 is an illustration of a display of a virtual reality game in an embodiment of the invention.

FIG. 3 is a simplified illustration of a “friends” window, listing a particular client's friends.

FIG. 4 is an illustration of a simplified Chat window in an embodiment of the invention.

### DETAILED DESCRIPTION

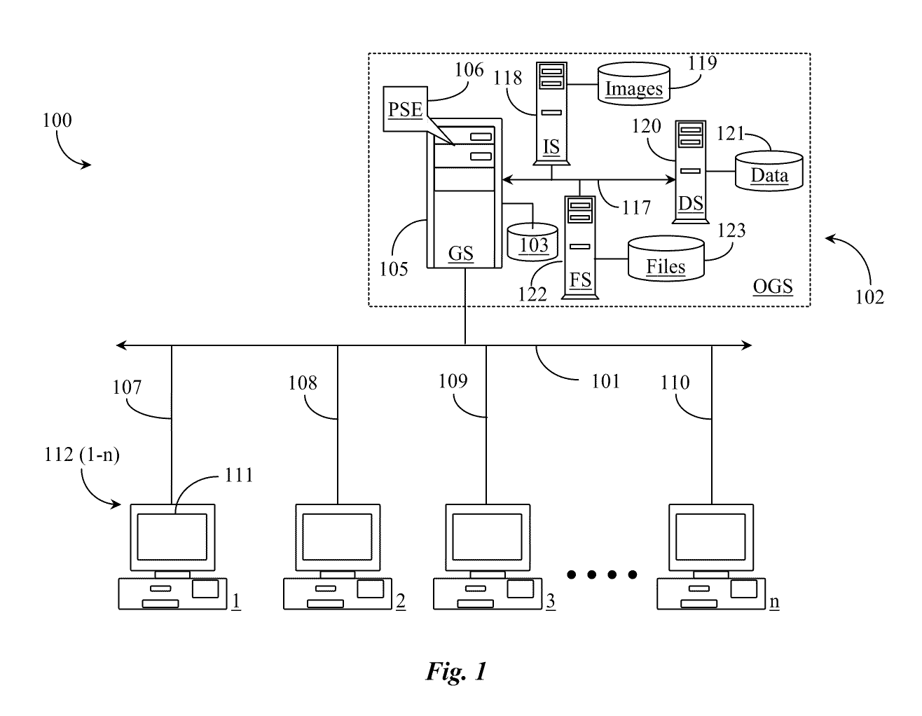

FIG. 1 is an architectural overview of a communications network 100 supporting user participation in a web-based Virtual Reality site in an embodiment of the present invention. Communications network 100 represents a digital wide-area-network (WAN) such as an Internet network. A network backbone 101 is illustrated in this example and represents all of the lines, equipment, and access points that make up the Internet network as a whole. Therefore, there are no geographic limitations to the practice of the present invention. Network 100 may include the Internet network and any connected sub-networks including telephone carriers that may provide access to network 100 physically represented herein by backbone 101.

In this example, network backbone 101 serves as a carrier network for communications between an online virtual reality site 102 and multiple clients 112 (1-n) of the virtual reality site. Site 102 represents any enterprise adapted to provide an online virtual environment (VE), including such as virtual worlds and online virtual reality games. Such virtual worlds and online games may be accessed by subscribing clients operating client computing devices 112 (1-n) having Internet access through any of the several known ways that Internet access may be attained.

Site 102 comprises a server or set of servers 105 including a digital medium 103 coupled thereto which is adapted to store all of the software and data required to enable server function as a Web server capable of serving electronic information pages to clients of site 102, and of registering clients for access to virtual environments and or online gaming available through site 102. The software for all of this functional activity executes on server 105 from machine-readable digital medium 103.

Client computing devices 112 (1-n) are desktop personal computers (PCs) in this example, but may in alternative examples be a mix of personal computers, hand-held digital appliances such as cellular telephones, personal digital assistants (PDAs), or any sort of computing appliance capable of Internet access. In this example, client computing devices 112 (1-n) are connected to network backbone 101 via logical access line connections 107, 108, 109, and 110. It is noted herein that client computing devices 112 (1-n) may connect to network backbone 101 through an Internet Service Provider (ISP) using a high-speed Internet access protocol like digital services line (DSL), broadband, T1-X, wireless (WiFi), cable/modem, and in other ways as well.

Each client device 112 (1-n) includes at least one central processing unit (CPU) coupled thereto and adapted to execute all of the software and data required to enable multi-task or dedicated computing function. Each client device 112 (1-n) includes a browser application 111 enabling access to pages served by server 105. Server 105 comprises, among other server components, a physics simulation engine (PSE) 106. PSE 106 provides real-time physics simulation of 3D objects of a virtual environment. In one embodiment PSE 106 is a rigid-body-dynamics simulation engine although other types and combinations thereof might be used in practice of the present invention.

In this example client computing devices 112 (1-n) are connected online over network backbone 101 with site 105 and are actively engaged in a VE offered through the server, such as a virtual world or other online game comprising one or more virtual three dimensional (3D) objects that require physics simulation of motion during game play or engagement with the virtual world.

Server 105 has in this particular embodiment a separate digital network connection 117 to various support servers and data repositories adapted to facilitate project and game service delivery. An image server (IS) 118 is provided within site 102 and is connected to server 105 over network 117. IS 118 has a digital medium 119 coupled thereto adapted to store all of the software and data required to enable function as an image server. IS 118 is adapted primarily to serve VR images to GS 105 from an image repository 119. Repository 119 may be a mechanical disk drive, a magnetic disk or an optical disk, or other known data repository without departing from the spirit and scope of the present invention.

A file server (FS) 122 is provided within site 102 and is connected to server 105 over network 117. FS 122 has a digital medium 123 coupled thereto and adapted to store all of the software and data required to enable function as a file server. FS 122 is adapted to serve files representing online virtual environments including virtual worlds, virtual games, etc. to server 105 for rendering. FS 122 manages games or files on file repository 123, which may be a mechanical, magnetic or an optical storage medium.

A data server (DS) 120 is provided within site 102 and is connected to server 105 via network 117. DS 120 has a digital medium 121 coupled thereto which is adapted to store all of the software and data required to enable server function as a data server. DS 120 is adapted to serve run-time data relative to any virtual environments being rendered by server 105. Data may include any technical data and information required to successfully render a VR in real time.

In practice of the invention, assume a number of clients 112 (1-n) are connected to server 105 and many are participating in interaction with a virtual environment running on the server, which may be a virtual game. One service provided by the server is that clients may be associated with other clients (friends), and degrees of friendship may be recorded in a number of ways, such as the record of communication and common activity between friends. In one aspect a user may invite other users into a friendship association, and this may be facilitated by, for example, sharing of profiles, which may indicate considerable information, characteristics, and preferences of individual users. Another service provided is that users may converse, which may be facilitated in various ways. One way in particular is that the service provides, in one embodiment, a chat facility whereby a user may initiate a chat session with one or more other users, whereby users in the chat session may post and answer text messages among them, as is widely known in chat room technology.

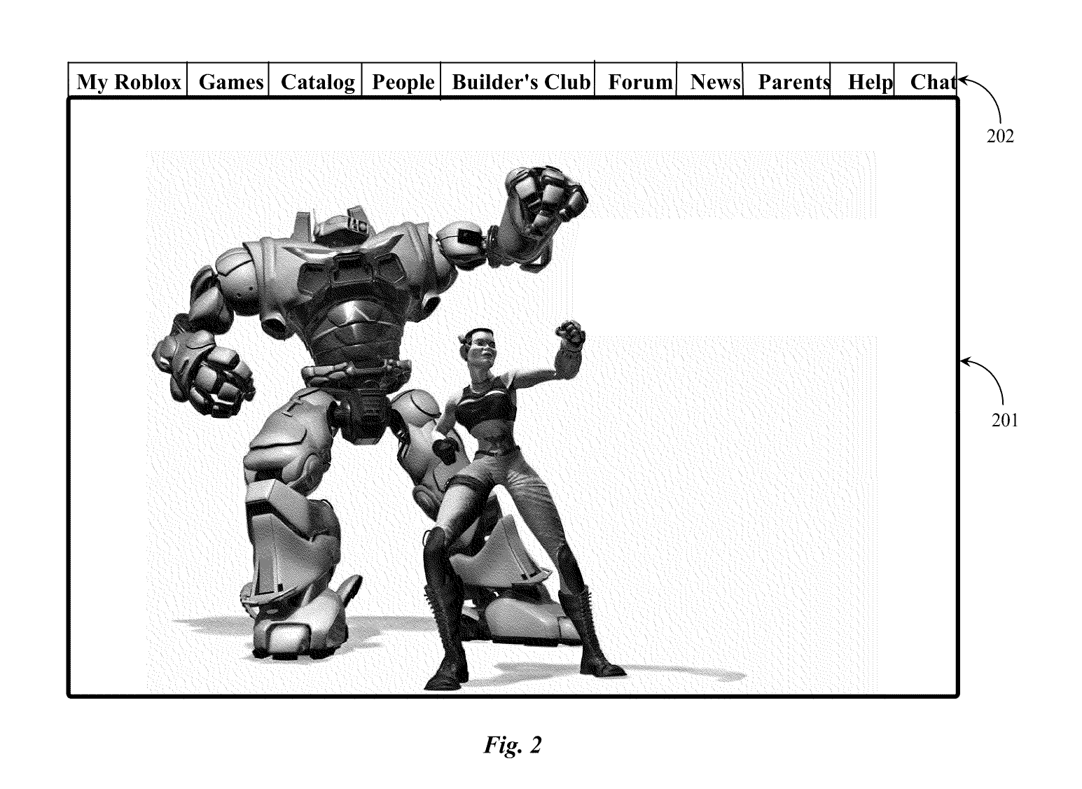

FIG. 2 is a block diagram illustrating a display area 201 on a client's monitor at one of the client stations 112(1-n), which, if the client is logged in to the web site and engaged in an interactive game, might display characters and other objects as shown minimally in FIG. 2 in the display area. Typically, of course, the objects in the display will be dynamic, and movement and game development will depend at least to some extent on pertinent input by the client through an input device.

In the interactive screen presented by server 105 in the client's display area, there will typically be, as is common in web pages, a variety of links through either or both of text and images, for the client to use to navigate to other pages and portions of the overall web presentation. A row 202 of interactive tabs is shown in FIG. 2, in which each tab is a link to another page or section of the overall web experience. There is a tab “My Roblox”, for example, which will take the client to a page where the client can access and may edit personal information. Catalog takes the client to a page or pages where different services or products may be browsed that are available for purchase or use. “News” takes the client to a page or pages where the latest developments for the enterprise are presented for the client to browse.

At the far right of the Tab bar is a tab labeled “Chat”, which accesses functionality to enable a peer-to-peer chat communication between the client and other persons currently logged in and active on one page or another of the enterprise system. This tab when selected enables the chat function. The link to chat might be elsewhere as well, such as an interactive radio button, and it may or may not be presented and available for selection in all or individual ones of pages presented or presentable to a client.

This chat function is a real-time, peer-to-peer online chat system which follows clients as they browse the VR system presented. The Chat link may be available to the client at any time, whether or not the client is engaged in a VR game. When a client selects the Chat link a window is presented with a list of the client's friends, as recorded in the administrative data for the client.

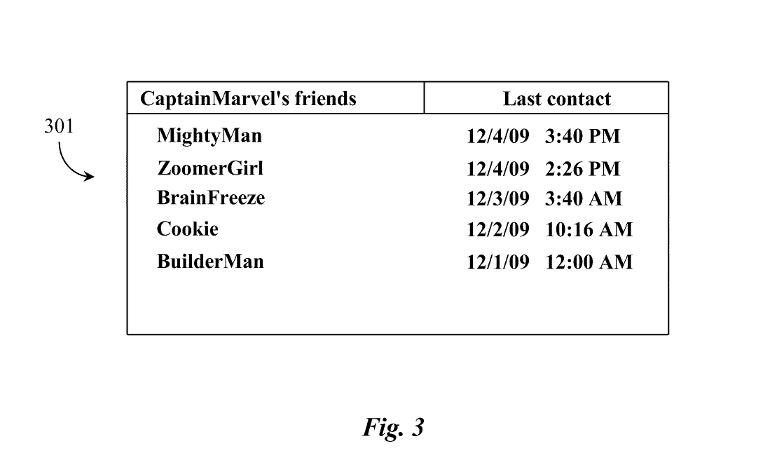

FIG. 3 is a simplified illustration of a “friends” window 301, listing a particular client's friends, as described above. The client's in this example have self-assigned aliases, and the particular client who is engaging the chat function in this example uses the alias CaptainMarvel, so the window is labeled CaptainMarvel's friends. The list of friends is drawn by the system from recorded data of friend associations either made by the client, or made by another client and approved by the client. The list in this example also presents data about the last contact between CaptainMarvel and each of the friends, and is sorted by the most recent contacts between the two friends.

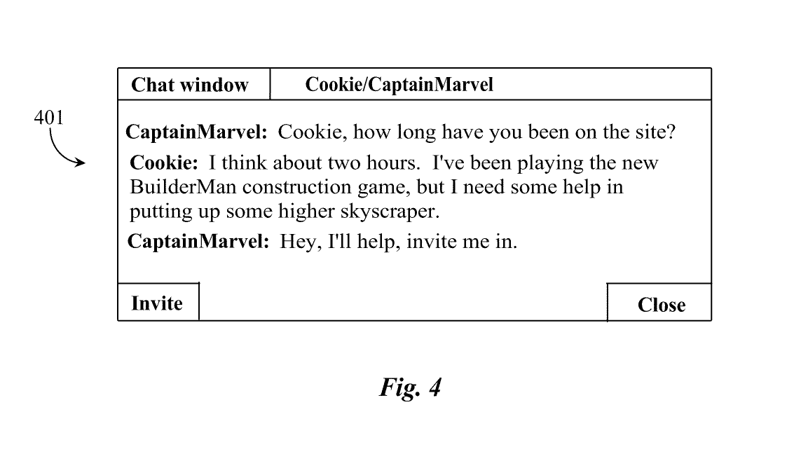

The client's aliases in the friends list are interactive links, and the client, in this case CaptainMarvel, who has engaged the Chat function may select one or more friends to instigate a Chat session. Assume CaptainMarvel selects Cookie. FIG. 4 is a simplified Chat window that may be presented in this embodiment, and will be presented to both Cookie and Captain Marvel. CaptainMarvel has addressed Cookie in the Chat, and Cookie has responded that she has been in a new game, that evidently allows a plurality of players, and would like CaptainMarvel to join in the game and help her in a construction task.

At any one time there may be tens or hundreds of clients engaged at the VR site, and many of these may be engaged in the new BuilderMan game. It will be apparent to the skilled artisan that each of the clients that has entered the new BuilderMan game is engaged in a separate and unique instance of the game, each instance being dynamically created in real-time by the enterprise software. The admin functions mentioned previously may track which clients are engaged in which games, and there may be a portal by which Captain Marvel might list all of the BuilderMan games currently in progress, and see what client is engaged in each game, and thus find the game which Cookie has initiated, and enter the same game. There might also be a search function whereby CaptainMarvel may enter search criteria (Cookie and BuilderMan game) and thus find the currently progressing game. But these prior art and conventional techniques leave much to be desired.

In an embodiment of the present invention Cookie, engaged in her own instance of the BuilderMan game, can use the Chat function to invite CaptainMarvel, who may then enter Cookie's instance of the BuilderMan game with a single click. In this example, Cookie (and CaptainMarvel) have an “Invite” action link in the lower left corner of the Chat window. The functionality is as follows:
If Cookie is presently engaged in a game, and also engaged in a Chat with CaptainMarvel, as is the case in this example, then the “Invite” link in Cookie's window is enabled to initiate an invitation to CaptainMarvel to enter her instance of the game.
When Cookie selects “Invite” in her window, an invitation link appears (or becomes active) in Captain Marvel's window. IN one embodiment the “Invite” text in CaptainMarvel's window changes to “Accept”, and is link-enabled such that if CaptainMarvel selects the “Accept” link, he is directed into the instance of BuilderMan in which Cookie is currently engaged.
Since CaptainMarvel is not, at this point in time, engaged in a game, selecting Invite has no function.

In another embodiment of the invention, a client, upon navigation to a page on the site which includes a link to enter a virtual Place, which is art terminology for such as games and activities, may elect to enter that Place, which links to a game that allows, or even requires a plurality of players. Using a client-side script a function A is attached to the “onclick” event of the link. If any functions are already attached to this event, function A will be called after the existing functions. When the client clicks the button to enter the game, function A will be called. Function A will do the following:
Reads the query string of the current URL and finds the ID of the place that the client is entering. If there is no ID, it will look for an ID parameter passed to the function.
Initiates an asynchronous request to a file B on the web server, with the ID as a parameter of the request.
   When File B is called, it:
   Gathers a list of that user's current online friends, and sorts them by the most recent date that the user and the friend have had a conversation through Chat. The list will be similar to the list shown in FIG. 3 that is displayed to the user on Chat. They will have the same data source.
Selects a subset of those friends, starting from the top of the list. The number of friends in the subset is determined by a configuration setting that is set not by the client, but by a representative of the enterprise hosting the server.
Look-up the name of the place that the user is entering, based on the ID that was passed to it as a parameter.
Constructs a place invitation to the subset of users. The place invitation will be a formatted request, but in plain text. For example, it will look something like “<invitation><placeid>ID</placeid><placename>Name of the place</placename></invitation>”.
Using the Chat functionality, the system sends this invitation to each of the clients in the subset.
Writes an HTTP response success message.

Each client selected from the list will receive a notification in their Chat that a game invitation was sent. In this example each of the friends online who were included in the subset chosen by file B will receive the invitation as if it were any other message being sent through Chat. Chat will detect the invitation based on the formatted request that was made and sent by file B. When an invitation is successfully identified, function D will be called. Function D:
Creates a URL from the place ID above.
Displays a small message in Chat that asks the client friend if they would like to enter that place with the user (accept the invitation to join the game or other activity), along with the URL that function D created. In some embodiments there may be an additional option that can be selected which will also invite the recipient's online friends. That invite process will call function A, with an additional ID parameter.
If the invite message is clicked, the recipient of the invite will enter the place along with the user by assertion of the URL for the placeID.

It should be noted that, in this instance, it is not necessary that all of the client's be actively engaged with the VR site where the games and activities are presented, that is, logged in to server 105. It is enough that there be a presence functionality at server 105 to determine if subscribing clients are online. This breadth may also be accorded to the enterprise' Chat in general. One client, engaged in a game or activity, or otherwise engaged and logged in to the VR site may initiate Chat sessions with other registered clients whether or not those clients are logged into the site. The same is true of the invitations to enter an activity that may be sent by the functionality of a logged-in client entering a Place that allows a plurality of clients to participate.

In embodiments of the invention described herein virtual reality places have been described as the web content to which clients might be invited to participate. This version, however, is exemplary only the Chat facilitated functionality might be utilized just as well for web sites having multiple pages of about any sort. For example, there might be a site marketing shoes (or any other merchandise) which also has a Chat functionality, and a client resident on a particular page or about to navigate to a particular page might use the invitation functionality to invite any of a plurality of persons (contacts) of the Chat facility to joining him or her on that page, and accepting the invitation will navigate the invited client to that page. Keeping the Chat open under this circumstance will allow the two (or more) clients to converse about the page (or anything else for that matter). Under this circumstance the functionality might serve to let the first client move on to other pages, issuing invitations as he or she goes, automatically, to allow the others to follow.

It should be apparent to the skilled person that the embodiments described above are exemplary, and that many details may be altered without departing from the spirit and scope of the invention. For example, the windows may be rendered in a broad variety of ways. The links illustrated may also be rendered in different ways. The software that enables functionality may be coded in many different ways as well. Design of web sites is notoriously well known to be variant. The invention in its broadest aspects may be enabled and practiced in many different ways. The invention is defined by the scope of the claims that follow.

What is claimed is:

1. A web-server engagement invitation system, comprising:
a computerized internet-connected server having a plurality of clients, serving content as web pages or presentations to individual ones of the clients through software executing from a machine-readable medium;
a chat system operable by the server through the software, providing chat communication between individual ones of the clients online; and
an invitation system operable through the chat system, enabling a first client engaged in or entering one of the pages or presentations to issue an invitation to one or more other receiving clients to enter the same page or presentation, the invitation served as a chat message through the chat system.

2. The system of claim 1 wherein the presentations are virtual reality activities and/or games.

3. The system of claim 1 wherein, upon selecting the invitation message by the receiving client, a URL is asserted directing the receiving client's web browser to the page or presentation engaged in or being entered by the first client.

4. The system of claim 2 wherein upon selecting the invitation message by the receiving client, a URL is asserted directing the receiving client's web browser to the virtual reality activity or game engaged in or about to be entered by the first client.

5. The system of claim 1 wherein the first client has a contact or friend association, and upon initiating the invitation process, a list of the client's contacts is presented, wherein the client may select or exclude contacts to receive the invitation.

6. The system of claim 4 wherein constraints are placed on the contacts list by the system.

7. A method for web-server engagement, comprising the steps of:
(a) serving content as web pages or presentations to individual clients among a plurality of clients by a computerized internet-connected server, through software executing from a machine-readable medium;
(b) providing a chat system operable by the server through the software, enabling chat communication between individual ones of the clients online; and
(c) issuing an invitation by a first client to one or more other receiving clients to enter the same page or presentation, the invitation served as a chat message through the chat system.

8. The method of claim 7 wherein in step (a) the presentations are virtual reality activities and/or games.

9. The method of claim 7 including a further step for selecting the invitation message by the receiving client, thereby asserting a URL directing the receiving client's web browser to the page or presentation engaged in or being entered by the first client.

10. The method of claim 7 including a further step for selecting the invitation message by the receiving client, thereby asserting a URL directing the receiving client's web browser to the virtual reality activity or game engaged in or being entered by the first client.

11. The method of claim 7 wherein the first client has a contact or friend association, and including a step for presenting a list of the client's contacts upon initiating the invitation process, wherein the client may select or exclude contacts to receive the invitation.

12. The method of claim 11 wherein constraints are placed on the contacts list by the system.
